(19) United States
(12) Patent Application Publication
(10) Pub. No.: US 2017/0052765 A1
(43) Pub. Date: Feb. 23, 2017

(54) METHOD AND SYSTEM FOR CREATING APP

(71) Applicants: PAI-TSUNG LEE, New Taipei City (TW); KUO-CHENG PARNG, Taipei (TW)

(72) Inventors: PAI-TSUNG LEE, New Taipei City (TW); KUO-CHENG PARNG, Taipei (TW)

(21) Appl. No.: 14/827,427

(22) Filed: Aug. 17, 2015

(51) Int. Cl. G06F 9/44; G06F 9/45

(52) U.S. Cl. CPC G06F 8/33; G06F 8/42

(57) ABSTRACT

A method and a system for creating APPs are disclosed. The method includes steps: installing a first APP to a mobile device; executing the first APP to show an editing interface on the mobile device; editing a code and content data corresponding to the code in the editing interface, respectively; storing the code and the content data to a storage block in a sandbox frame by an operating system of the mobile device; compiling the code and the content data as an object file by a compiler installed in the mobile device; and converting the object file into a second APP which is executable in the operating system by a linker installed in the mobile device. An advantage of the present invention is that APPs can be created in a mobile device.

### FIELD OF THE INVENTION

The present relates to a method and system for creating APPs (mobile applications). More particularly, the present relates to a method and system for creating APPs by an APP run on a mobile device. Creating APP does not necessarily depend on computers with complex development environments. It benefits development and promotion of APPs.

### BACKGROUND OF THE INVENTION

APPs are the most popular mobile communication products right now. Every APP can utilize hardware in a mobile device where it is installed to provide a specific service. For example, GPS (Global Positioning System) APPs utilize the GPS module in a mobile phone to inform the user where he is, further providing a visual navigation service to guide the way to the user's destination. Gaming APPs receive gamers' action via a touch screen and then output the results as images (via the touch screen) and sound (via a speaker module) for entertainment. Social APPs link users' mobile devices with cloud servers to on-line communicate with all friends around the world in time. It saves cost that a traditional phone call occurs. Meanwhile, videos and work documents can be shared over the APPs. It is obvious that development of APPs is unfolding.

For the engineers who develop various APPs, although there are lots of tools and libraries which can be utilized in developing jobs, development of APPs is still cumbersome and time-consuming. A complete APP has to run on all platforms. However, not only these platforms have different architectures, but also developing tools used are different. There are two giant platforms, Android and iOS systems, in the market. JAVA and Objective C are used to develop APPs, respectively. Because hardware of mobile devices is keeping changing, syntaxes of each programming language change accordingly. It is not an easy job for an engineer to master one programming language. It is very hard to familiar with two or more programming languages for one project. It does not include editing of interfaces and design of cloud servers. Therefore, there are many new developing tools coming out, providing software engineers an integrated cross-platform development environment. Such development environment may be a code of a programming language, compiled as object files for different systems and then run by each run-time environment. The integrated cross-platform development environment meets the market demands. However, it is unfavorable that such architecture needs huge computer resources. In general, huge software contents are loaded into computers. Aspects of operating interfaces and auxiliary libraries are complex. If the jobs of compilation and execution of APPs are shifted to mobile devices, e.g. a tablet, there is no suitable tool available.

In addition to the problem of cross-platform and computer resources of developing tools, education of APP development is another arising problem. Since the programming achievements (code) have to be loaded into the mobile device to see the effects of the operation, emulators in the computer side often cannot effectively use new simulation hardware in the mobile devices. Some problems occurred may be a screen which is not able to completely show the contents or new G-sensor which cannot be driven. Under such situation, many people will lose their interests on developing APPs after repeated debugs. How to improve APP programming environment is an issue for APP development.

Last, since distribution of APPs goes through different channels, for example, APPs applied on iOS via Apple Store, Android via Google Play Store, and HTML5 via specific URLs, it is a lousy job to prepare different version of codes for an APP to distribute to all channels at the same. How to utilize cloud resources to reduce the mentioned trouble is another challenge in front of APP development.

Therefore, a new method and system for creating APPs are desired. By the method and system, APPs can be generated in a mobile device. Less computer resources are required. It is not necessary to be developed in a computer. The created APP may be for the operating system of the mobile device, or it is cross-platform. The method and system should assist in education of APP development. Preferably, the system includes a cloud operating device to encapsulate a code and related content data as various executable file, distributed to different channels for user's download.

### SUMMARY OF THE INVENTION

This paragraph extracts and compiles some features of the present invention; other features will be disclosed in the follow-up paragraphs. It is intended to cover various modifications and similar arrangements included within the spirit and scope of the appended claims.

In order to settle the problems mentioned above, a method for creating APPs is disclosed by the present invention. The method includes steps of: A. installing a first APP to a mobile device; B. executing the first APP to show an editing interface on the mobile device; C. editing a code and content data corresponding to the code in the editing interface, respectively; D. storing the code and the content data to a storage block in a sandbox frame by an operating system of the mobile device; E. compiling the code and the content data as an object file by a compiler installed in the mobile device; and F. converting the object file into a second APP which is executable in the operating system by a linker installed in the mobile device. The editing interface is able to display changes of the content data in time and show an interface of the second APP.

According to the present invention, the method further comprises steps after step D: D1. reading the code and/or the content data; D2. editing the code and/or the content data; and D3. storing the edited code and/or content data to the storage block by the operating system. Preferably, the method further comprises steps after step D: D4. processing a syntax test on the code in the sandbox frame; and D5. if there is a syntax error of the code found after the syntax test, showing related error messages in the editing interface and not processing step E; if there is no syntax error of the code found after the syntax test, processing step E.

Another method for creating APPs is also disclosed in the present invention. The method includes steps of: A. installing a first APP to a mobile device, wherein the first APP comprises an executing engine; B. executing the first APP to show an editing interface on the mobile device by the executing engine; C. editing a code and content data corresponding to the code in the editing interface, respectively; D. storing the code and the content data to a storage block in a sandbox frame by an operating system of the mobile device; and E. encapsulating the executing engine, the code and the content data as a second APP. The editing interface is able to display changes of the content data in time and show an interface of the second APP.

According to the present invention, the mentioned method further includes steps after step D: D1. reading the code and/or the content data; D2. editing the code and/or the content data; and D3. storing the edited code and/or content data to the storage block by the operating system. Preferably, the method further includes steps after step D: D4. processing a syntax test on the code in the sandbox frame; and D5. if there is a syntax error of the code found after the syntax test, showing related error messages in the editing interface and not processing step E; if there is no syntax error of the code found after the syntax test, processing step E.

Still another method for creating APPs is disclosed in the present invention. The method includes steps: A. installing a first APP to a mobile device; B. executing the first APP to show an editing interface on the mobile device; C. editing a code and content data corresponding to the code in the editing interface, respectively; D. storing the code and the content data to a storage block in a sandbox frame by an operating system of the mobile device; E. processing a syntax test on the code in the sandbox frame; F. if there is a syntax error of the code found after the syntax test, showing related error messages in the editing interface and not processing step G; if there is no syntax error of the code found after the syntax test, uploading the code and the content data to a cloud server; G. compiling the code and the content data as an object file for a specific platform in the cloud server; and H. converting the object file into a second APP which is executable in the specific platform. The editing interface is able to display changes of the content data in time and show an interface of the second APP.

According to the present invention, the mentioned method further includes steps after step F: F1. reading the code and/or the content data; F2. editing the code and/or the content data; and F3. storing the edited code and/or content data to the cloud server or the storage block.

Still another method for creating APPs is disclosed in the present invention. The method includes steps of: A. installing a first APP to a mobile device, wherein the first APP includes an executing engine; B. executing the first APP to show an editing interface on the mobile device by the executing engine; C. editing a code and content data corresponding to the code in the editing interface, respectively; D. storing the code and the content data to a storage block in a sandbox frame by an operating system of the mobile device; E. processing a syntax test on the code in the sandbox frame; F. if there is a syntax error of the code found after the syntax test, showing related error messages in the editing interface and not processing step G; if there is no syntax error of the code found after the syntax test, uploading the code and the content data to a cloud server; and G. encapsulating an executing engine, the code and the content data as a second APP for a specific platform in the cloud server. The editing interface is able to display changes of the content data in time and show an interface of the second APP. The second APP is executed in the specific platform by the executing engine.

According to the present invention, the mentioned method further includes steps after step F: F1. reading the code and/or the content data; F2. editing the code and/or the content data; and F3. storing the edited code and/or content data to the cloud server or the storage block.

Another aspect of the present invention is to provide a system for creating APPs. The system includes: a first APP, executed for providing an editing interface, wherein the editing interface is used to edit a code and content data corresponding to the code, respectively; the first APP processes a syntax test on the code and compiles the code and the content data as an object file; and a mobile device, operated by an operating system and installed with the first APP, for converting the object file into a second APP which is executable in the operating system by an installed linker, includes: a touch screen, for showing the editing interface to edit the code and the content data; a memory unit, for storing APPs, the code and the content data, wherein the code and the content data are restricted to be stored in a specific location; and a processing unit, for executing the first APP by the operating system and copying the code and the content data to the specific location. The first APP accessing data in the specific location forms a sandbox frame. Syntax test on the code is carried on in the sandbox frame. The editing interface is able to display changes of the content data in time and show an interface of the second APP.

Preferably, the mentioned system further includes: a cloud server, for receiving the code and the content data, compiling the code and the content data as an object file for a specific platform and converting the object file into a second APP which is executable in the specific platform.

Another system for creating APPs is also disclosed in the present invention. The system includes: a first APP, including a first executing engine, executed by the first executing engine to show an editing interface on the mobile device, wherein the editing interface is used to edit a code and content data corresponding to the code, respectively; the first APP processes a syntax test on the code and encapsulates the executing engine, the code and the content data as a second APP; and a mobile device, operated by an operating system and installed with the first APP, including: a touch screen, for showing the editing interface to edit the code and the content data; a memory unit, for storing APPs, the code and the content data, wherein the code and the content data are restricted to be stored in a specific location; and a processing unit, for executing the first APP by the operating system and the first executing engine, and copying the code and the content data to the specific location. The first APP accessing data in the specific location forms a sandbox frame. Syntax test on the object file is carried on in the sandbox frame. The editing interface is able to display changes of the content data in time and show an interface of the second APP.

Preferably, the mentioned system further includes: a cloud server, for receiving the code and the content data, and encapsulating the code and the content data as a second APP for a specific platform, wherein the second APP is executed by a second executing engine in the specific platform.

According to the present invention, the mobile device may be a tablet or a smart phone. The content data may be background designs, sounds, images, characters and/or APP templates. The code and the content data are edited in a code editing interface and a content data editing interface, respectively. The specific platform includes an operating system and a processor architecture.

The present invention utilizes the first APP or the executing engine and the sandbox frame to create new APPs in a mobile device. It doesn't have to depend on computers. In addition, by the cloud server, a code and its content data can be encapsulated as different executable files. The final converted APPs can be for the operating system of the mobile device only, or cross-platform. Last, since the programming platform is the mobile device, by operation of WYSIWYG (What You See Is What You Get) interface, it benefits education of APP development.

### BRIEF DESCRIPTION OF THE DRAWINGS

FIG. 1 shows a system for creating APPs according to the present invention.

FIG. 2 shows an editing interface and a content data editing interface.

FIG. 3 illustrates a storing way in the storage block.

FIG. 4 is a flow chart of a method for creating APPs in the mobile device.

FIG. 5 is a flow chart of another method for creating APPs in the mobile device.

FIG. 6 is a flow chart of still another method for creating APPs in the mobile device.

FIG. 7 is a flow chart of still another method for creating APPs in the mobile device.

FIG. 8 is a flow chart of still another method for creating APPs in the mobile device.

FIG. 9 is a flow chart of still another method for creating APPs in the mobile device.

FIG. 10 is a flow chart of still another method for creating APPs in the mobile device.

FIG. 11 shows another system for creating APPs according to the present invention.

FIG. 12 is a flow chart of a method for creating APPs.

FIG. 13 is a flow chart of another method for creating APPs.

FIG. 14 is a flow chart of still another method for creating APPs.

FIG. 15 is a flow chart of still another method for creating APPs.

FIG. 16 is a flow chart of still another method for creating APPs.

### DETAILED DESCRIPTION OF THE PREFERRED EMBODIMENTS

The present invention will now be described more specifically with reference to the following embodiments.

### First Embodiment

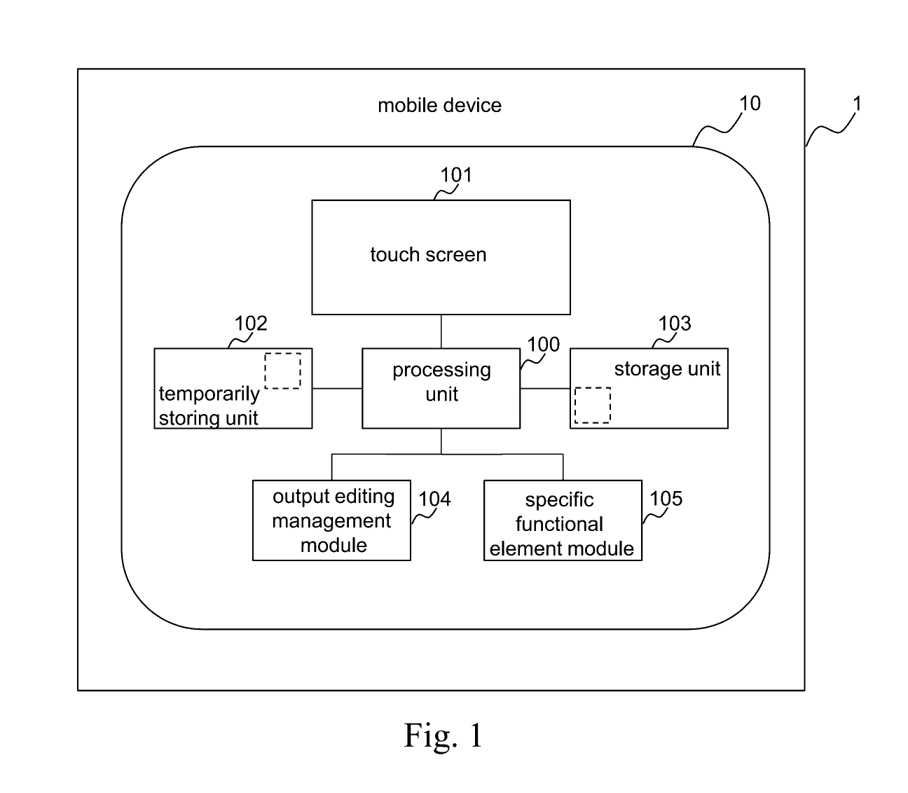

Please refer to FIG. 1. It shows an embodiment of a system for creating APPs according to the present invention. The system includes a mobile device 1 and a first APP run thereon. The mobile device 1 is operated by an operating system 10 and installed the APP. Hardware wise, the mobile device 1 has a processing unit 100, a touch screen 101, a temporarily storing unit 102, a storage unit 103, an output editing management module 104 and a specific functional element module 105. Functions of the hardware are illustrated below.

The processing unit 100 is the CPU (Central Processing Unit) in the mobile device 1. It may vary as differences of function settings or different system architectures. For example, the mobile device 1 may be a tablet or a smart phone. Although the operating system 10 on each device supports multiplex and can execute APPs, the tablet cannot be used for telecommunication as the smart phone does. Choices of CPUs are different. Therefore, according to the present invention, the processing unit 100 has to be able to execute APPs by the operating system 10 or an executing engine. Meanwhile, the processing unit 100 is also able to copy a code and content data corresponding to the code to the specific location. Regarding the specific location, more detailed descriptions will be provided later.

The touch screen 101 can show what the operating system 10 provides and pass data edited by users to the operating system 10. A main function of the touch screen 101 is to show an editing interface to edit the mentioned code and content data. The temporarily storing unit 102 and the storage unit 103 are used to temporarily and permanently store data. For the mobile device 1, the temporarily storing unit 102 may be a RAM (Random Access Memory) or a cache in the processing unit 100. The storage unit 103 may be a SSD (Solid State Disk), ROM (Read Only Memory) or an external memory card. For a better illustration, the temporarily storing unit 102 and the storage unit 103 are collected to be named as a memory unit. Since every operating system and processing unit have different strategies for memory management (it may be different depending on the size of main memory and situation of use), when one APP is executed, the code and content data may be all temporarily stored in the RAM or cache; when the when the APP is not executed, the code and content data may be saved in the ROM. However, it is possible that computing results may be temporarily stored in the ROM when executing. Hence, overall, the memory unit is used to store APPs, the mentioned code and content data while it is not limited to be stored in the temporarily storing unit 102 or the storage unit 103 only. It should be noticed that the code and the content data are restricted to be stored in the specific location. The specific location may be some storage blocks (shown as dashed frames in FIG. 1) of the temporarily storing unit 102 and/or storage unit 103. Except the code and content data used by the present invention, other programs, codes or data cannot be stored in the specific location. Of course, the specific location will not expend to other existing data storage area. The restriction of the specific location is to form a sandbox frame in the memory unit.

The output editing management module 104 is under the control of the processing unit 100 for managing operations of each output port or element of the mobile device 1. These output port or element may be a USB port, an external sources hole, physical buttons, a camera module, a speaker module, a Bluetooth module, a Wi-Fi sub-module, etc. The processing unit 100 can link to the Internet by the Wi-Fi sub-module via the output editing management module 104. The specific functional element module 105 is under the control of the processing unit 100 to operate some elements with specific functions. These elements with specific functions include, but are not limited to, a gravity sensor, an electronic compass, a gyroscope, a distance sensor, an ambient light sensor, a Hall Effect sensor, etc. It should be noticed that the operating system 10 plays a communication interface for APPs and the processing unit 100. It is able to drive the processing unit 100 to run the hardware elements in the mobile device 1 according to the requirements from the APP.

After the mentioned APP is installed in the mobile device 1, the operating system 10 is executed to provide an editing interface shown on the touch screen 101. For the APP to be processed by this way, it should be a machine code executable in the mobile device 1, or an object file executed by an installed virtual machine (such as a Java Bytecode executed by the Java Runtime Environment). Now, the mobile device 1 can be installed with a compiler and a linker, used to compile the code and content data as an object file and convert the object file into a second APP which is executable in the operating system.

According to the spirit of the present invention, APPs made in other forms of codes can also be applied to the mobile device 1 and executed. For example, APPs programmed and encapsulated by scripting languages (e.g. JavaScript), can be executed by a browser or an executing engine to show on the mobile device 1 through the operating system 10. For some APPs made by fourth generation programming languages, such as LIVECODE, the code doesn't have to be compiled and the results from an interpreter can be shown or further executed on the mobile device 1 by the operating system 10. The APP creating method differs from that out of scripting languages, but the execution form is close to that of script programmed APPs. It is also suitable for the present invention.

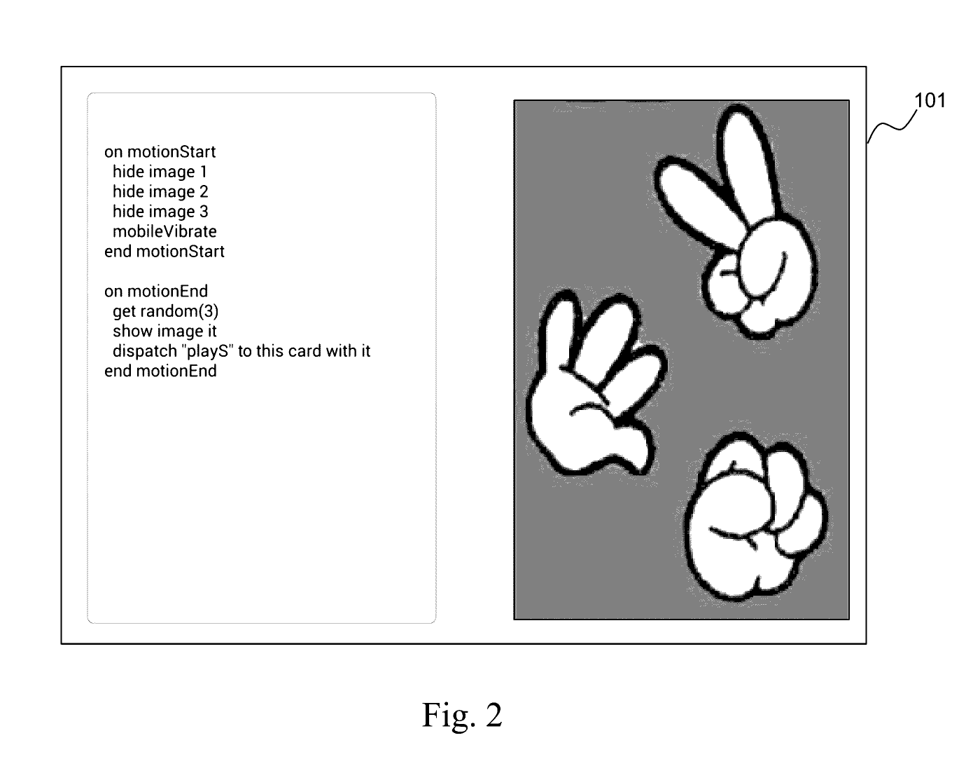

The mentioned editing interface is used to edit a code and content data corresponding to the code, respectively. Please refer to FIG. 2. Preferably, the code and the content data are created and edited in a code editing interface (left on FIG. 2) and a content data editing interface (right on FIG. 2), respectively. The code editing interface and the content data editing interface can show up on the touch screen 101 at the same time so that it is convenient to edit the code. If the size of the touch screen 101 is smaller, the code editing interface and the content data editing interface can show up in turns by switching. As shown in FIG. 2, the code editing interface for editing the code is convenient to check with the corresponding figures (e.g. image 1 represents a scissors, image 2 represents a stone and image 3 represents a paper) in the content data editing interface on the right side. Users can change figures in the content data editing interface and modify the code accordingly. It should be noticed that the editing interface is able to display changes of the content data in time. The overall pattern shown in the editing interface (the content data editing interface) is an interface (screen) of a second APP which will be created and executed in the future. According to the present invention, the mentioned content data may be background designs, sound, image, characters and/or APP template about the second APP. These content data can be edited in the content data editing interface. Results of the editing job can be temporarily stored in the memory unit and will be further edited several times in the future. It is not necessary to be done at once.

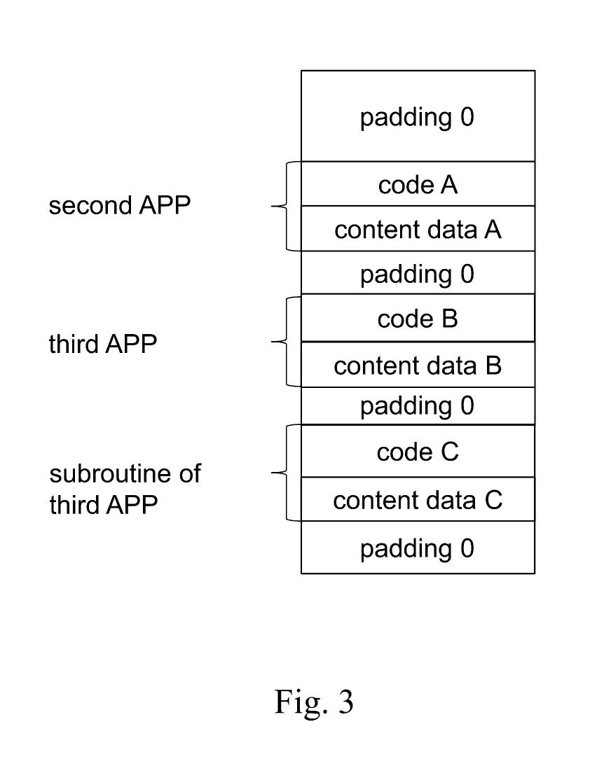

For the said storage block, since it is possible to program codes for more than two APPs, the storing way is shown in FIG. 3. A code A and content data A of the second APP are stored adjacently. A code B and content data B of a third APP are also stored adjacently. Codes and content data of different APPs are separated by padding 0. The third APP may have a subroutine. A code C and content data C of the subroutine can be stored in another location. When it is required to compile or execute, the code B, content data B, code C and content data C can be processed together. An advantage is to simplify complexity of editing the codes.

If the code is executed by an executing engine (e.g. a browser) for a scripting language, or edited based on an interpreting programing language, the architecture of the first APP may include an executing engine. The first APP is executed by the executing engine to show an editing interface on a mobile device. The editing interface is used to edit a code and content data corresponding to the code. The first APP processes a syntax test on the code. It can also encapsulate the executing engine (it is not necessary if the executing engine is a browser), the code and the content data as a second APP.

If the code needs to be compiled as an object file before being executed, the first APP can be directly executed to provide an editing interface (via a run-time environment). The editing interface is used to edit a code and content data corresponding to the code. The first APP can process a syntax test on the code and compile the code and the content data to an object file. It should be emphasized that no matter which kind of the first APP accesses the data in the specific location, it forms the mentioned sandbox frame. Syntax test on the code is processed in the sandbox frame.

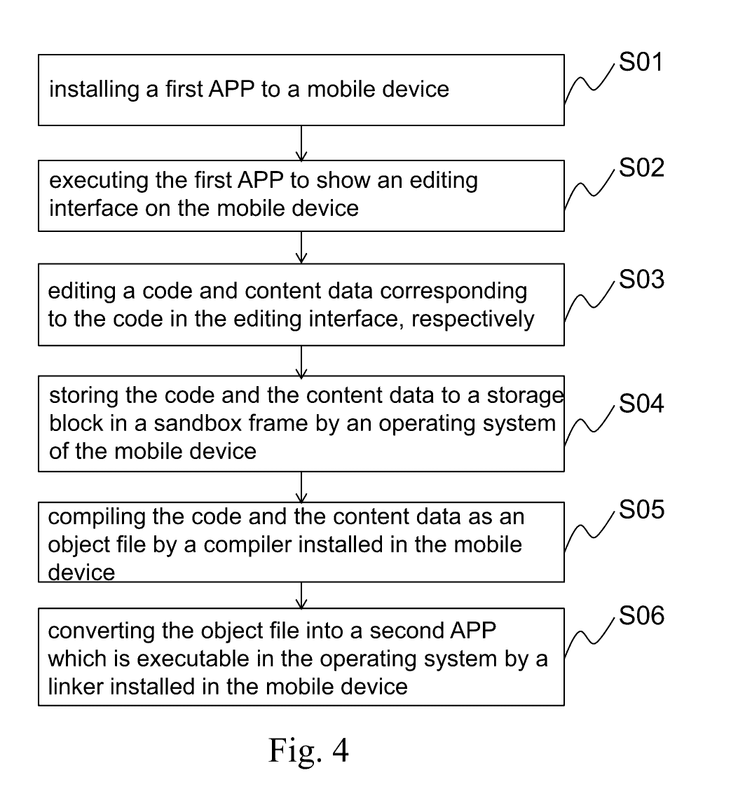

By using the system mentioned above, a method for creating APPs is disclosed. Please refer to FIG. 4. The method includes steps as below. First, install a first APP to a mobile device (S01). Then, the operating system 10 executes the first APP to show the mentioned editing interface on the mobile device 1 (S02). Users can edit a code and content data corresponding to the code in the editing interface (S03). Preferably, as mentioned above, the editing interface is separated into the code editing interface and content data editing interface. They are used to generate and edit the code and the content data, respectively. Then, the operating system 10 of the mobile device 1 stores the code and the content data to a storage block in a sandbox frame (S04). By a compiler installed in the mobile device, compile the code and the content data as an object file (S05). Last, by a linker installed in the mobile device 1, convert the object file into a second APP which is executable in the operating system 10 (S06). It should be noticed that the code applied in the method needs to be compiled to an object file and before being executed as the second APP in the mobile device 1. In step S03, the editing interface should be able to display changes of the content data in time and show the interface of the second APP.

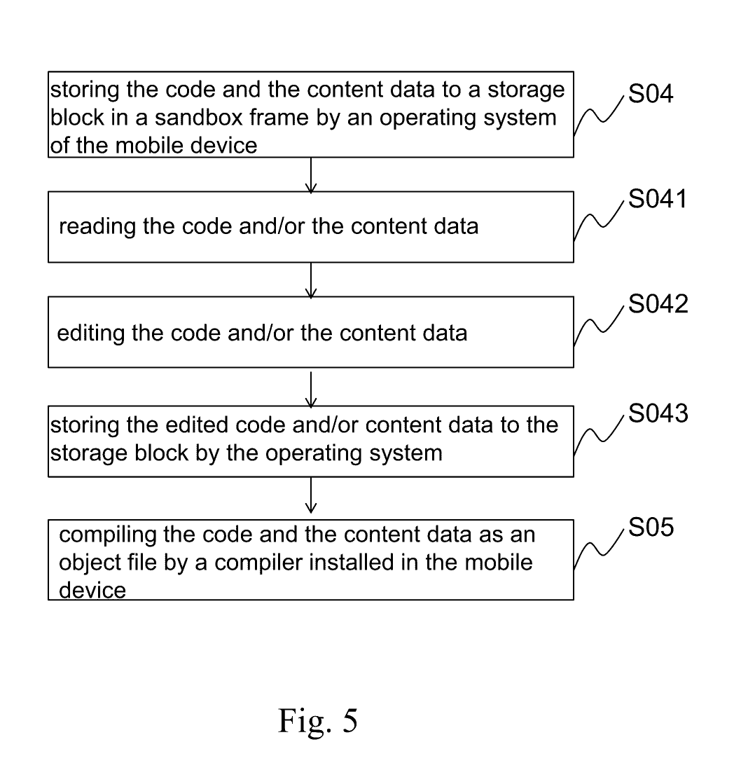

As mentioned above, results of editing the code can be temporarily stored in the memory unit, and will be further edited several times in the future. Therefore, the method may has steps between step S04 and step S05 (Please see FIG. 5): reading the code and/or the content data (S041); editing the code and/or the content data (S042); and storing the edited code and/or content data to the storage block by the operating system 10 (S043). Step S041 to step S043 can be repeated again and again till the code is completed.

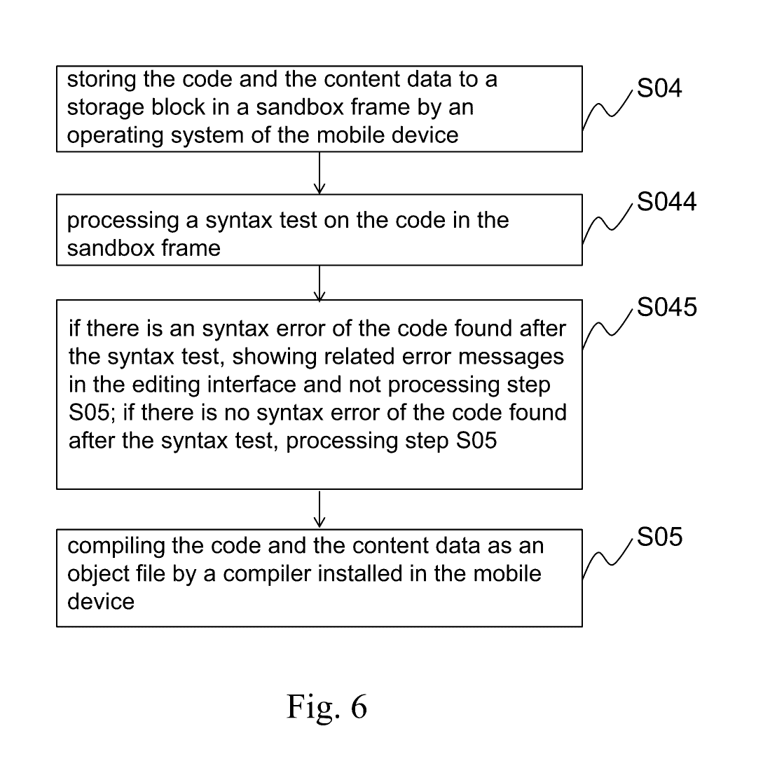

Before the object file is generated, the first APP can process a syntax test on the code. Thus, there are steps between step S04 and step S05 (Please see FIG. 6). Process a syntax test on the code in the sandbox frame (S044). If there is a syntax error of the code found after the syntax test, show related error messages in the editing interface and not processing step S05. Now, users can modify the code according to the error messages and repeat step S04 again. If there is no syntax error of the code found after the syntax test, process step S05 (S045).

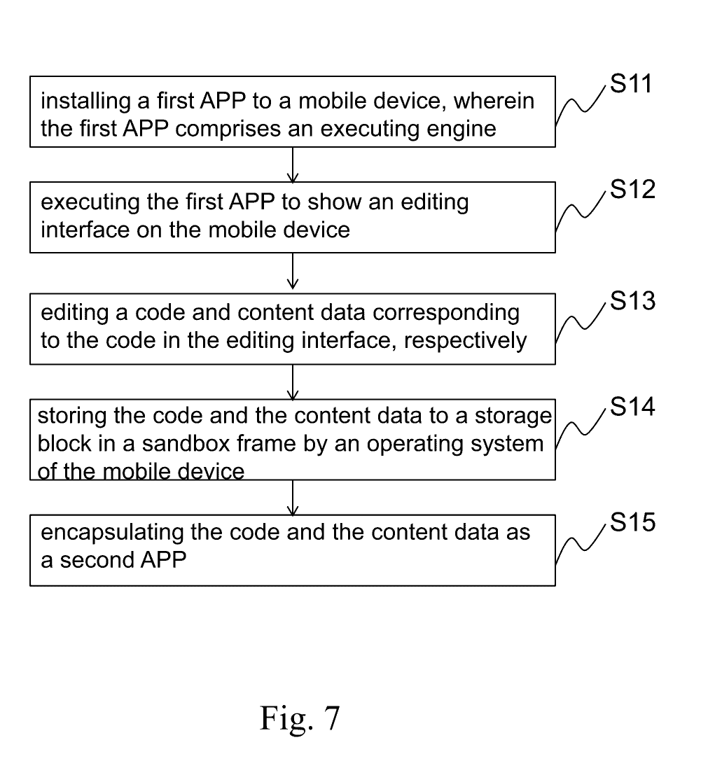

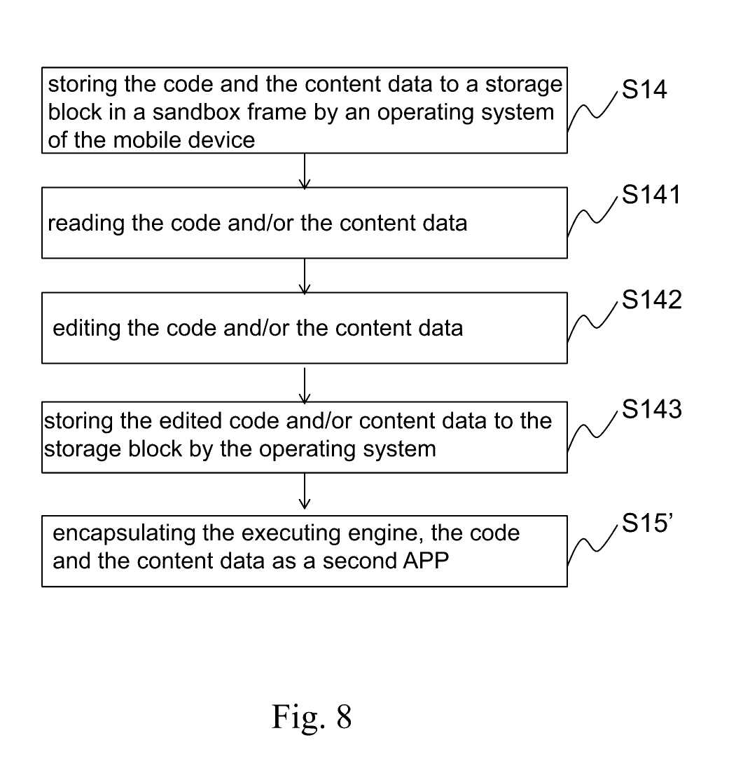

If the code is executed by an executing engine for a scripting language, or edited based on an interpreting programing language, the method mentioned above should be modified. Please see FIG. 7. The modified method includes steps as below. First, install a first APP to a mobile device. Here, the first APP includes an executing engine (S11). Then, the executing engine executes the first APP to show an editing interface on the mobile device 1 (S12). Users can edit a code and content data corresponding to the code in the editing interface, respectively (S13). Next, by the operating system 10 of the mobile device 1, store the code and the content data to a storage block in a sandbox frame (S14). Finally, the first APP encapsulates the code and the content data as a second APP (S15). If the executing engine of the scripting language is not a browser, then step S15 is modified as the first APP encapsulates the executing engine, the code and the content data as a second APP (S15′) as shown in FIG. 8. Step S15 mentioned below can be exchanged with step S15′. Now, created second APP can be executed by the encapsulated executing engine or browser via the operating system 10 of the mobile device 1. Similarly, when editing, the editing interface can be able to display changes of the content data in time and show the interface of the second APP.

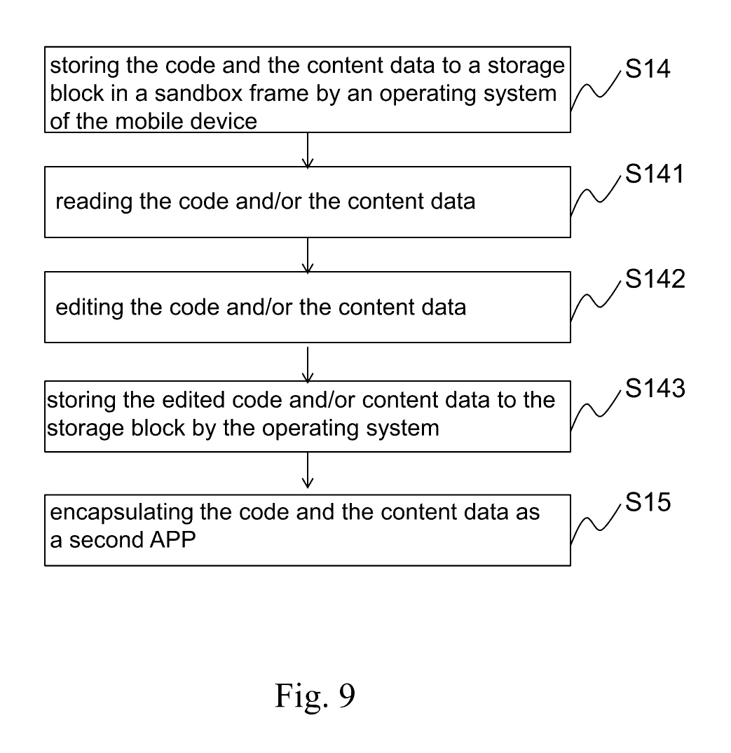

As mentioned above, results of editing the code can be temporarily stored in the memory unit, and will be further edited several times in the future. Therefore, there can be several steps between step S14 and step S15 as below (Please see FIG. 9): reading the code and/or the content data; (S141); editing the code and/or the content data (S142); and by the operating system 10, storing the edited code and/or content data to the storage block (S143). Step S141 to step S143 can be repeated again and again till the code is completed.

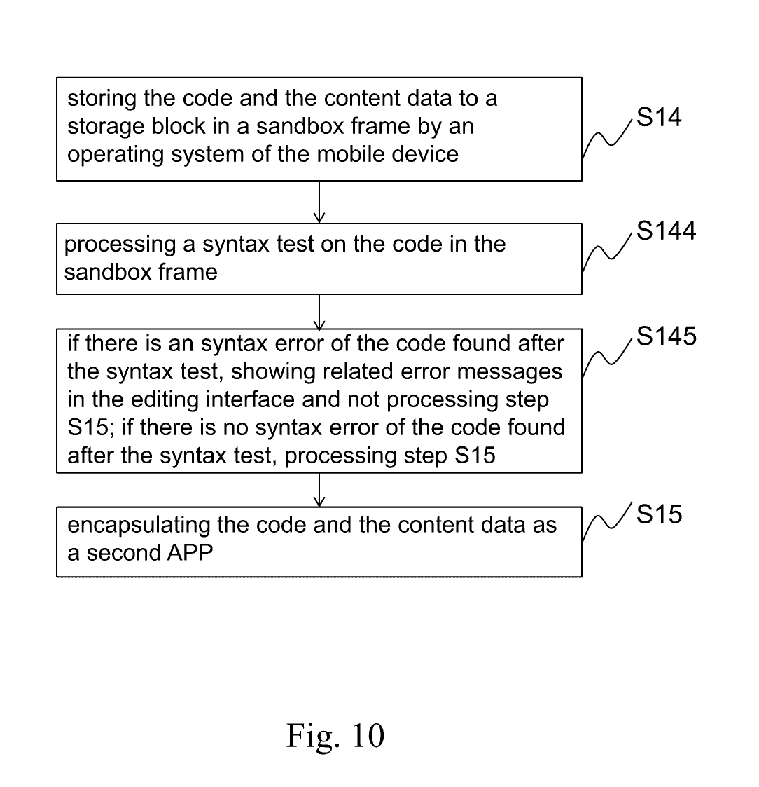

According to the present invention, the first APP can process a syntax test on the code. Hence, there can be several steps between step S14 and step S15 (Please see FIG. 10): processing a syntax test on the code in the sandbox frame (S144); and if there is a syntax error of the code found after the syntax test, showing related error messages in the editing interface and not processing step S15; if there is no syntax error of the code found after the syntax test, processing step S15 (S145).

### Second Embodiment

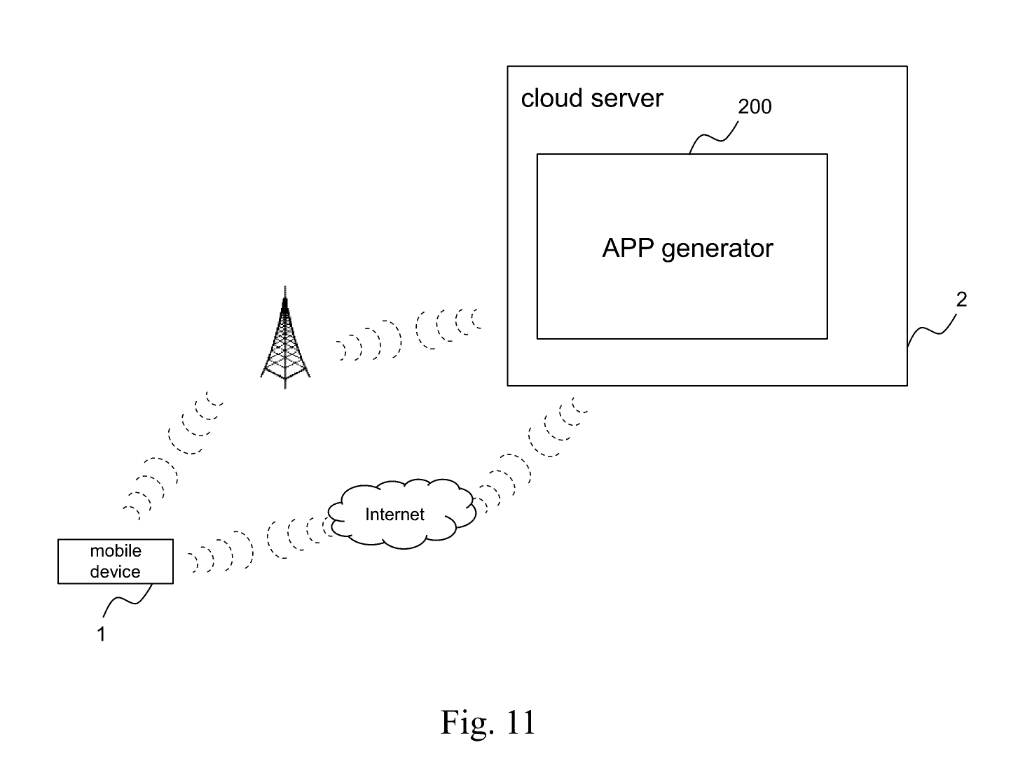

According to the spirit of the present invention, the system for creating APPs in the first embodiment is not limited to be executed only in the mobile device 1. The system can further include a cloud server 2 for providing functions of creation and distribution of APPs in the cloud. Please see FIG. 11, the cloud server 2 and the mobile device 1 are connected via a mobile network or Internet to receive the code and content data. The cloud server 2 can also compile the received code and the content data as an object file for a specific platform. Finally, the cloud server 2 converts the second object file as a second APP which is executable in the specific platform. The second APP can be distributed to different channels for users to download in different platforms. The so-called specific platform includes a processor architecture and an operating system, e.g. Android operating system under the ARM architecture or window 8.1 operating system under the x86 architecture.

The cloud server 2 has hardware resources huger than the mobile device 1. Therefore, the cloud server 2 can further do some jobs that the mobile device 1 can not to do. For example, compile the code and content data of the second APP to object files for various operating platforms. This job is done by an APP generator 200 in the cloud server 2. The APP generator 200 may be hardware module or massive software in the cloud server 2. The APP generator 200 needs to deal with generating methods of executable files of all kinds of mobile device operating systems under specific hardware architecture. It might be equipped with all development environments for all programming languages while the code the APP generator 200 receives may be programmed by only one programming language.

It is obvious from the description above that the code the cloud server 2 deals with needs to be compiled to an object file before being executed. However, according to the spirit of the present invention, if the code is executed by an executing engine for a scripting language, or edited based on an interpreting programing language, it is applicable. The cloud server 2 is used to receive the code and the content data, encapsulate a second executing engine (it can be the same as the executing engine in the first APP or different therefrom), the code and the content data as a second APP for a specific platform. The second APP is executed in the specific platform by the second executing engine. The second executing engine may also not be encapsulated. Since the cloud server 2 is powerful, the APP generator 200 can have necessary run-time environments and executing engines, dealing with all codes at the same time.

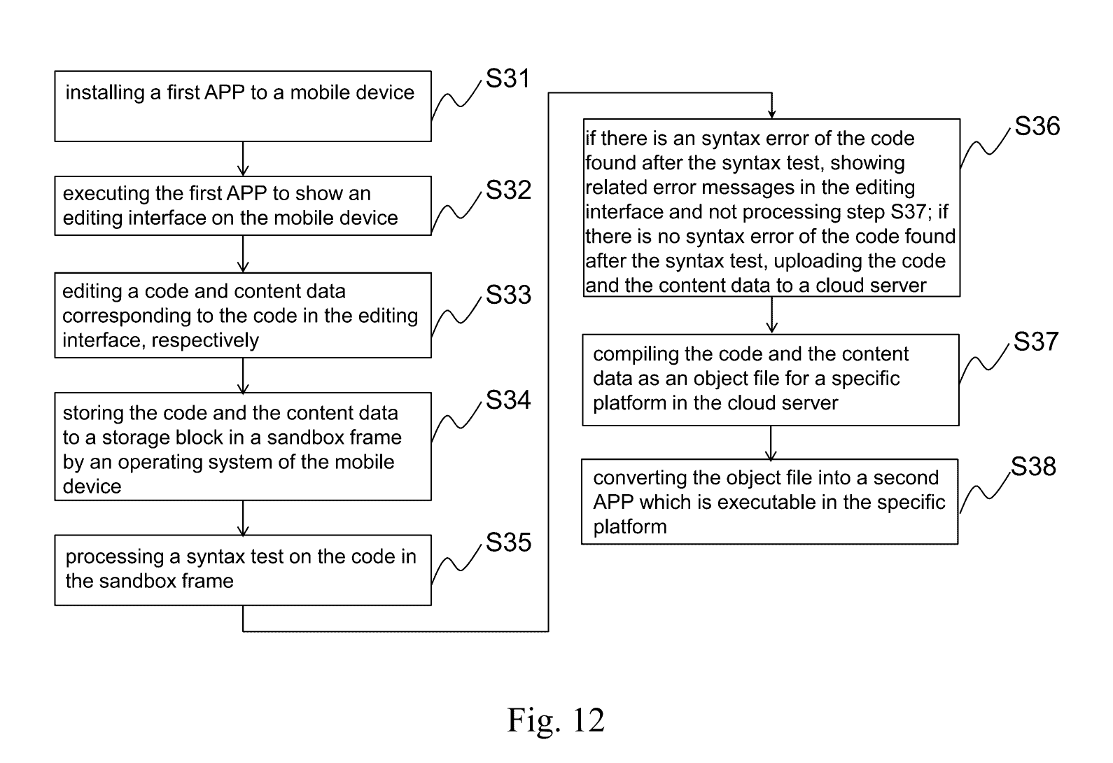

With operation of the system shown in FIG. 11, the present invention discloses another method for creating APPs. Please refer to FIG. 12. The method includes steps below. First, install a first APP to the mobile device 1 (S31). Then, the operating system 10 executes the first APP to show an editing interface on the mobile device 1 (S32). Users edit a code and content data corresponding to the code in the editing interface, respectively. (S33) Store the code and the content data to a storage block in a sandbox frame by the operating system 10 of the mobile device 1 (S34). Next, process a syntax test on the code in the sandbox frame of the first APP. (S35). If there is a syntax error of the code found after the syntax test, show related error messages in the editing interface and do not process step S37. Now, users can modify the code according to the error messages and repeat step S35. If there is no syntax error of the code found after the syntax test, upload the code and the content data to the cloud server 2. (S36). At this moment, in the cloud server 2, the APP generator 200 compiles the code and the content data as an object file for a specific platform (S37). Finally, the APP generator 200 converts the object file into a second APP which is executable in the specific platform (S38). The editing interface should be able to display changes of the content data in time and show the interface of the second APP.

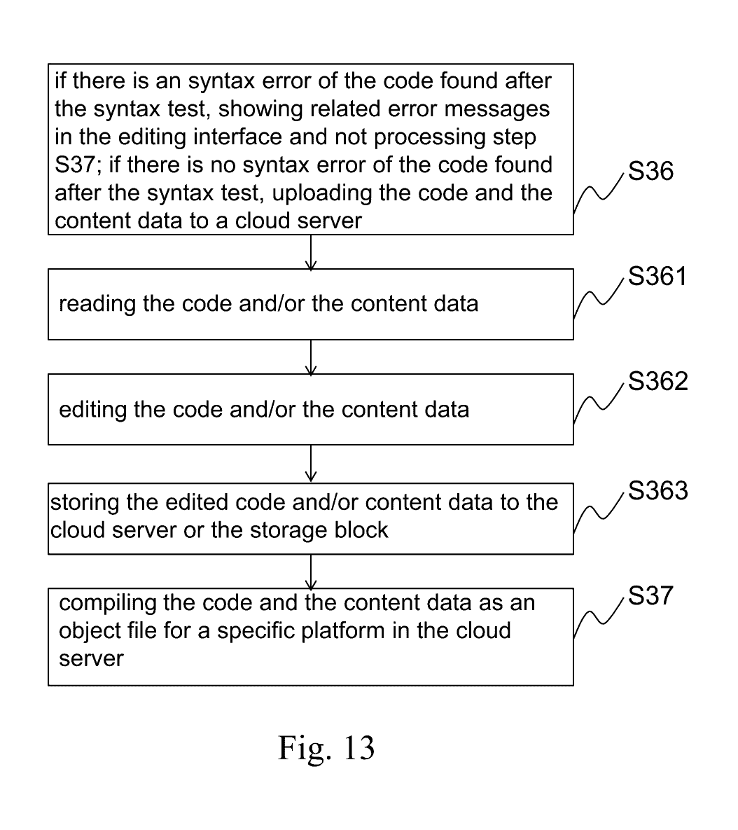

Like the previous embodiment, results of editing the code be temporarily stored and will be further edited several times in the future. Hence, there are some steps between step S36 and step S37 as below (Please see FIG. 13): reading the code and/or the content data (S361); editing the code and/or the content data (S362); and store the edited code and/or content data to the cloud server or the storage block (S363). It should be noticed that in step S363, if the code and/or the content data have a great modification in logic, the edited code and/or content data can be stored back to the storage block and repeat step S35 again. If the editing job is processed on a verified code for a small modification, the modified code and/or content data can be stored in the cloud server 2. An advantage of the present invention can be found that sharing resources can be achieved. This is that the uploaded code and content data can be further edited and modified by other users in the cloud server 2. Step S361 to step S363 can be repeated again and again till the code is completely modified or edited.

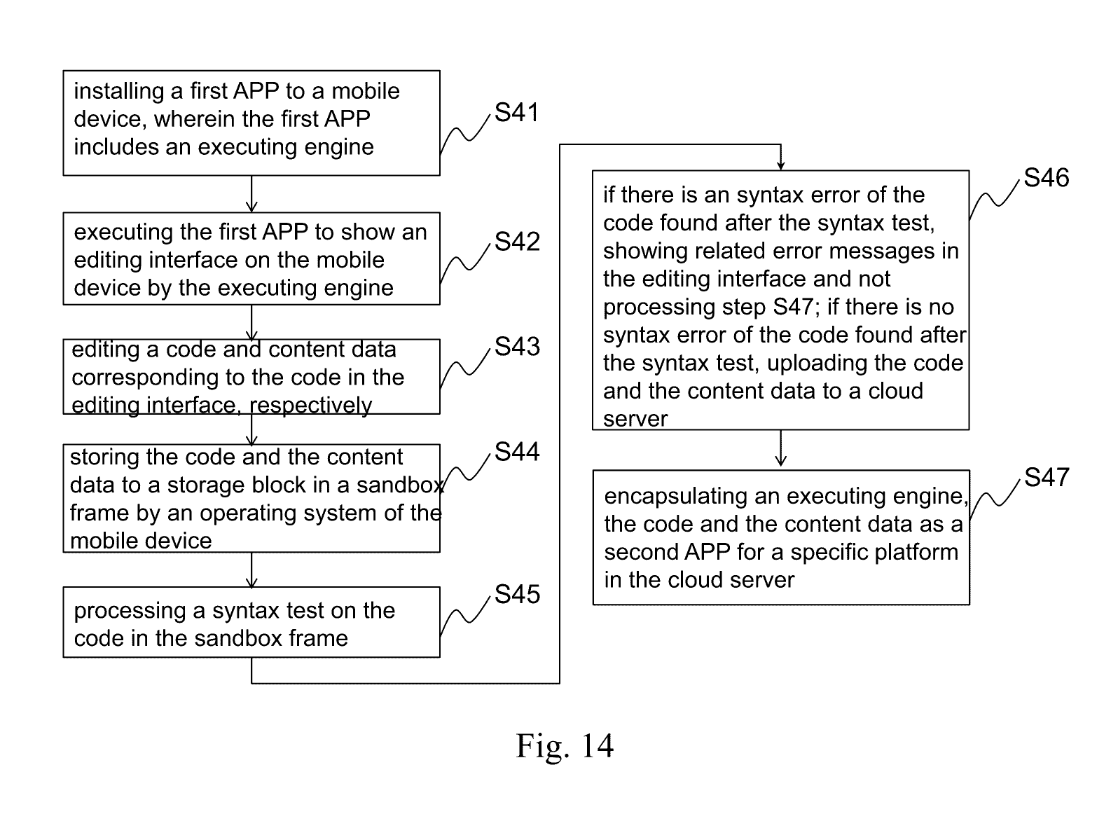

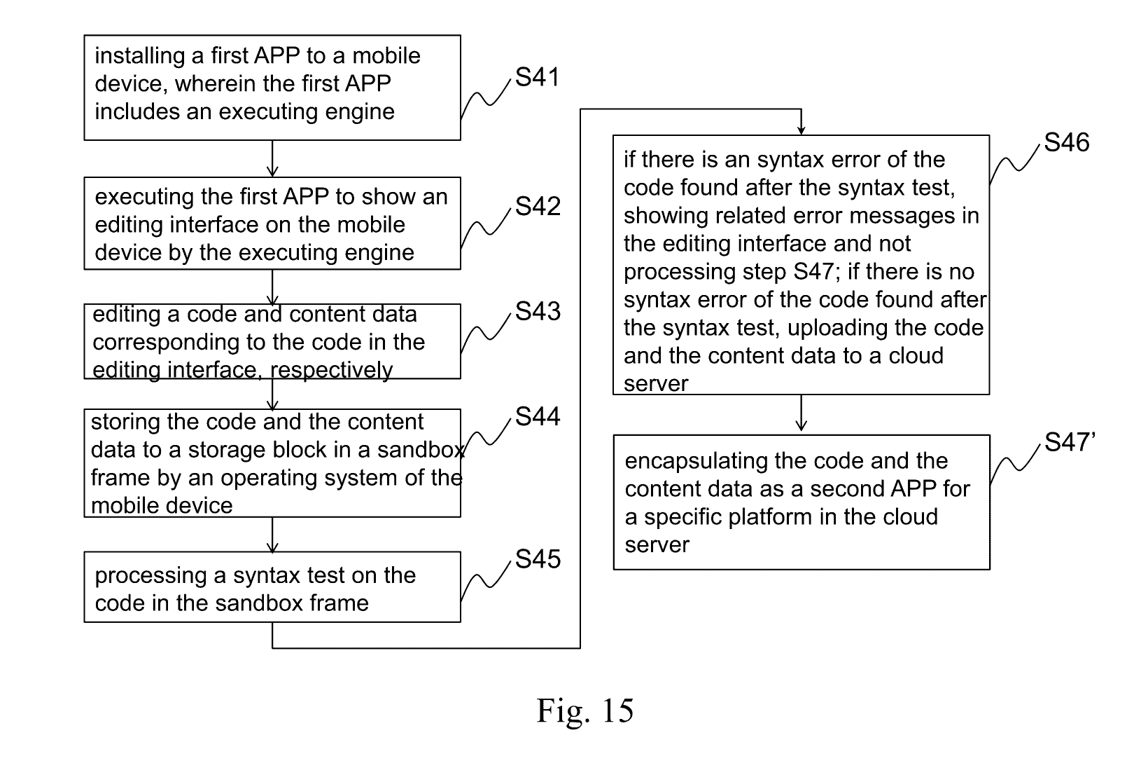

From the above description one may know that the code needs to be compiled to an object file before being executed. If the code is executed by an executing engine for a scripting language, or edited based on an interpreting programing language, the above method needs to be modified. Please see FIG. 14. First, install a first APP to the mobile device 1. The first APP includes an executing engine (S41). Then, the executing engine executes the first APP to show an editing interface on the mobile device 1 (S42). Users edit a code and content data corresponding to the code in the editing interface, respectively (S43). Next, store the code and the content data to a storage block in a sandbox frame by an operating system 10 of the mobile device 1 (S44). Then, process syntax test on the code in the sandbox frame (S45). If there is a syntax error of the code found after the syntax test, show related error messages in the editing interface and do not process step S47. Now, users can modify the code according to the error messages and repeat step S45. If there is no syntax error of the code found after the syntax test, upload the code and the content data to the cloud server 2. (S46). Finally, in the cloud server 2, encapsulate an executing engine, the code and the content data as a second APP for a specific platform (S47). If the executing engine for the scripting language is a browser, step S47 is changed as that encapsulate the code and the content data as a second APP for a specific platform in the cloud server 2 (S47′) as shown in FIG. 15 Step 47 mentioned below can be exchanged with step 47′ for the same reason. The editing interface should be able to display changes of the content data in time and show the interface of the second APP. The second APP is able to be executed in the specific platform by the executing engine.

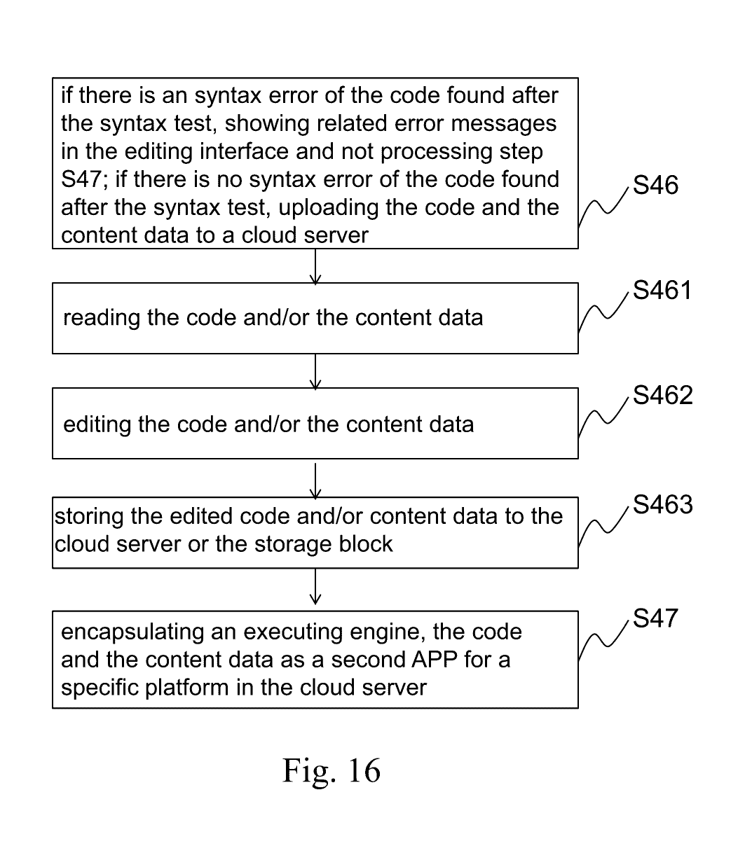

Similarly, results of editing the code be temporarily stored and will be further edited several times in the future. Therefore, there are several steps between step S46 and step S47 as below (Please see FIG. 16): reading the code and/or the content data (S461); editing the code and/or the content data (S462); and storing the edited code and/or content data to the cloud server or the storage block (S463). In step S463, if the procedure is under editing or debugging, the edited code and/or content data are stored back to the storage block. If the code and content data have been uploaded to the cloud server 2, the modified code and/or content data is store to the cloud server 2. Step S461 to step S463 can be repeated again and again till the code is completely modified.

While the invention has been described in terms of what is presently considered to be the most practical and preferred embodiment, it is to be understood that the invention needs not be limited to the disclosed embodiment. On the contrary, it is intended to cover various modifications and similar arrangements included within the spirit and scope of the appended claims, which are to be accorded with the broadest interpretation so as to encompass all such modifications and similar structures.

What is claimed is:

1. A method for creating APP (mobile application), comprising steps of:
A. installing a first APP to a mobile device;
B. executing the first APP to show an editing interface on the mobile device;
C. editing a code and content data corresponding to the code in the editing interface, respectively;
D. storing the code and the content data to a storage block in a sandbox frame by an operating system of the mobile device;
E. compiling the code and the content data as an object file by a compiler installed in the mobile device; and
F. converting the object file into a second APP which is executable in the operating system by a linker installed in the mobile device,
wherein the editing interface is able to display changes of the content data in time and show an interface of the second APP.

2. The method according to claim 1, further comprising steps after step D:
D1. reading the code and/or the content data;
D2. editing the code and/or the content data; and
D3. storing the edited code and/or content data to the storage block by the operating system.

3. The method according to claim 1, further comprising steps after step D:
D4. processing a syntax test on the code in the sandbox frame; and
D5. if there is a syntax error of the code found after the syntax test, showing related error messages in the editing interface and not processing step E; if there is no syntax error of the code found after the syntax test, processing step E.

4. The method according to claim 1, wherein the content data are background designs, sounds, images, characters and/or APP templates.

5. The method according to claim 1, wherein the code and the content data are edited in a code editing interface and a content data editing interface, respectively.

6. A method for creating APP, comprising steps of:
A. installing a first APP to a mobile device, wherein the first APP comprises an executing engine;
B. executing the first APP to show an editing interface on the mobile device by the executing engine;
C. editing a code and content data corresponding to the code in the editing interface, respectively;
D. storing the code and the content data to a storage block in a sandbox frame by an operating system of the mobile device; and
E. encapsulating the code and the content data as a second APP,
wherein the editing interface is able to display changes of the content data in time and show an interface of the second APP.

7. The method according to claim 6, further comprising steps after step D:
D1. reading the code and/or the content data;
D2. editing the code and/or the content data; and
D3. storing the edited code and/or content data to the storage block by the operating system.

8. The method according to claim 6, further comprising steps after step D:
D4. processing a syntax test on the code in the sandbox frame; and
D5. if there is a syntax error of the code found after the syntax test, showing related error messages in the editing interface and not processing step E; if there is no syntax error of the code found after the syntax test, processing step E.

9. The method according to claim 6, wherein step E is changed to be encapsulating the executing engine, the code and the content data as a second APP.

10. The method according to claim 6, wherein the content data are background designs, sounds, images, characters and/or APP templates.

11. The method according to claim 6, wherein the code and the content data are edited in a code editing interface and a content data editing interface, respectively.

12. A method for creating APP, comprising steps of:
A. installing a first APP to a mobile device;
B. executing the first APP to show an editing interface on the mobile device;
C. editing a code and content data corresponding to the code in the editing interface, respectively;
D. storing the code and the content data to a storage block in a sandbox frame by an operating system of the mobile device;
E. processing a syntax test on the code in the sandbox frame;
F. if there is a syntax error of the code found after the syntax test, showing related error messages in the editing interface and not processing step G; if there is no syntax error of the code found after the syntax test, uploading the code and the content data to a cloud server;
G. compiling the code and the content data as an object file for a specific platform in the cloud server; and
H. converting the object file into a second APP which is executable in the specific platform,
wherein the editing interface is able to display changes of the content data in time and show an interface of the second APP.

13. The method according to claim 12, further comprising steps after step F:
F1. reading the code and/or the content data;
F2. editing the code and/or the content data; and
F3. storing the edited code and/or content data to the cloud server or the storage block.

14. The method according to claim 12, wherein the content data are background designs, sounds, images, characters and/or APP templates.

15. The method according to claim 12, wherein the code and the content data are edited in a code editing interface and a content data editing interface, respectively.

16. The method according to claim 12, wherein the specific platform comprises an operating system and a processor architecture.

17. A method for creating APP, comprising steps of:
A. installing a first APP to a mobile device, wherein the first APP comprises an executing engine;
B. executing the first APP to show an editing interface on the mobile device by the executing engine;
C. editing a code and content data corresponding to the code in the editing interface, respectively;
D. storing the code and the content data to a storage block in a sandbox frame by an operating system of the mobile device;
E. processing a syntax test on the code in the sandbox frame;
F. if there is a syntax error of the code found after the syntax test, showing related error messages in the editing interface and not processing step G; if there is no syntax error of the code found after the syntax test, uploading the code and the content data to a cloud server; and
G. encapsulating an executing engine, the code and the content data as a second APP for a specific platform in the cloud server;
wherein the editing interface is able to display changes of the content data in time and show an interface of the second APP; the second APP is executed in the specific platform by the executing engine.

18. The method according to claim 17, further comprising steps after step F:
F1. reading the code and/or the content data;
F2. editing the code and/or the content data; and
F3. storing the edited code and/or content data to the cloud server or the storage block.

19. The method according to claim 17, wherein the content data are background designs, sounds, images, characters and/or APP templates.

20. The method according to claim 17, wherein the code and the content data are edited in a code editing interface and a content data editing interface, respectively.

21. The method according to claim 17, wherein the specific platform comprises an operating system and a processor architecture.

22. A system for creating APP, comprising:
a first APP, executed for providing an editing interface, wherein the editing interface is used to edit a code and content data corresponding to the code, respectively; the first APP processes a syntax test on the code and compiles the code and the content data as an object file; and
a mobile device, operated by an operating system and installed with the first APP, for converting the object file into a second APP which is executable in the operating system by an installed linker, comprising:
a touch screen, for showing the editing interface to edit the code and the content data;
a memory unit, for storing APPs, the code and the content data,
wherein the code and the content data are restricted to be stored in a specific location; and
a processing unit, for executing the first APP by the operating system and copying the code and the content data to the specific location,
wherein the first APP accessing data in the specific location forms a sandbox frame; syntax test on the code is carried on in the sandbox frame; the editing interface is able to display changes of the content data in time and show an interface of the second APP.

23. The system according to claim 22, further comprising:
a cloud server, for receiving the code and the content data, compiling the code and the content data as an object file for a specific platform and converting the object file into a second APP which is executable in the specific platform.

24. The system according to claim 22, wherein the content data are background designs, sounds, images, characters and/or APP templates.

25. The system according to claim 22, wherein the code and the content data are edited in a code editing interface and a content data editing interface, respectively.

26. The system according to claim 23, wherein the specific platform comprises an operating system and a processor architecture.

27. A system for creating APP, comprising:
a first APP, comprising a first executing engine, executed by the first executing engine to show an editing interface on the mobile device,
wherein the editing interface is used to edit a code and content data corresponding to the code, respectively; the first APP processes a syntax test on the code and encapsulates the executing engine, the code and the content data as a second APP; and
a mobile device, operated by an operating system and installed with the first APP, comprising:
a touch screen, for showing the editing interface to edit the code and the content data;
a memory unit, for storing APPs, the code and the content data, wherein the code and the content data are restricted to be stored in a specific location; and
a processing unit, for executing the first APP by the operating system and the first executing engine, and copying the code and the content data to the specific location,
wherein the first APP accessing data in the specific location forms a sandbox frame; syntax test on the object file is carried on in the sandbox frame; the editing interface is able to display changes of the content data in time and show an interface of the second APP.

28. The system according to claim 27, comprising:
a cloud server, for receiving the code and the content data and encapsulating the code and the content data as a second APP for a specific platform, wherein the second APP is executed by the second executing engine in the specific platform.

29. The system according to claim 27, wherein the content data are background designs, sounds, images, characters and/or APP templates.

30. The system according to claim 27, wherein the code and the content data are edited in a code editing interface and a content data editing interface, respectively.

31. The system according to claim 28, wherein the specific platform comprises an operating system and a processor architecture.

32. The system according to claim 28, wherein the cloud server further encapsulates a second executing engine, the code and the content data as a second APP.
